(19) United States
(12) Patent Application Publication
(10) Pub. No.: US 2025/0307103 A1
(43) Pub. Date: Oct. 2, 2025

(54) SYSTEM AND METHOD FOR CIPHER-CODED DATETIME-BASED DATA LATENCY TRACING IN END-TO-END DATA PROCESSING PIPELINES

(71) Applicant: THE DUN & BRADSTREET CORPORATION, Jacksonville, FL (US)

(72) Inventors: Brack Thompson, Parkville (AU); Gabriel Charvat, Atlanta, GA (US); Ann Leigh Parry, Easton, PA (US)

(73) Assignee: THE DUN & BRADSTREET CORPORATION, Jacksonville, FL (US)

(21) Appl. No.: 19/098,486

(22) Filed: Apr. 2, 2025

Related U.S. Application Data
(60) Provisional application No. 63/573,232, filed on Apr. 2, 2024.

(51) Int. Cl. G06F 11/30; G06F 11/32

(52) U.S. Cl. CPC G06F 11/3075; G06F 11/3082; G06F 11/323

(57) ABSTRACT

An instrumentation and measurement tool that provides a technological solution for precise data flow latency tracing within end-to-end data processing pipelines from ingestion of raw data through to consuming product systems. Cipher-coded date-time stamps for data field tagging replace numeric timestamps to eliminate data validation errors that can be triggered if numeric timestamps were used in data fields where character data is expected. The resulting latency metrics are systematically aggregated and presented through a dashboard, providing comprehensive insights into the performance of end-to-end data processing pipelines with adaptive monitoring and alerting capabilities.

This application claims priority from and the benefit of provisional patent application Ser. No. 63/573,232, filed on Apr. 2, 2024, the entire contents of which are incorporated herein by reference, in their entirety.

### BACKGROUND OF THE DISCLOSURE

### 1. Field of the Disclosure

The present disclosure relates to a method and apparatus for determining latency time in software systems. More particularly it relates to measurement of the time to perform a given analysis function.

### 2. Description of the Related Art

Efficient monitoring of data flow latency is critical for ensuring optimal performance in end-to-end data processing pipelines. Traditional timestamping methods using numeric timestamps often encounter challenges related to validation errors and compatibility. This disclosure addresses these issues by introducing a cipher-coding technique applicable to various database technologies in the context of end-to-end data processing pipelines.

There is a need for a robust mechanism that systematically logs timestamped events at various stages of data movement in end-to-end data processing pipelines.

Further there is a need for real-time analytics, enabling administrators to make informed decisions based on comprehensive insights into end-to-end data processing pipeline performance.

There is also a need for an integrated alerting system that responds to predefined thresholds of deviation from normal operation.

### SUMMARY OF THE DISCLOSURE

In general, an embodiment of the disclosure is directed to a method for measuring data flow latency in an end-to-end data processing pipeline comprising the steps of periodically injecting a plurality of numerical date-time stamped data packets into the data processing pipeline, the packets being configured so that they are not rejected by the pipeline as in an unacceptable format, and not processed by the pipeline as valid data, and determining when each of the plurality of data packets has been processed out of the pipeline to derive measures of the latency time between when each of the plurality of data packets was injected into the pipeline and when the respective data packet was processed out of the pipeline.

The method can further comprise converting the numerical date-time stamps into alpha cipher code compliant with processing in the pipeline.

The method can further comprise aggregating the measures of latency time.

The method can further comprise aggregating the measures of latency time to produce a graph of the manner in which latency time varies as a function of time. The graph can be displayed on a user dashboard.

The present disclosure is also directed to a system for measuring latency of data processing in a data processing pipeline, comprising: a first apparatus including a programmed digital processor for periodically injecting a plurality of numerical date-time stamped data packets into the data processing pipeline, the packets being configured so that they are not rejected by the pipeline as in an unacceptable format, and not processed by the pipeline as valid data, and a second apparatus including a programmed digital processor for determining when each of the plurality of data packets has been processed out of the pipeline to derive measures of the latency time between when each of the plurality of data packets was injected into the pipeline and when the respective data packet was processed out of the pipeline

### BRIEF DESCRIPTION OF THE DRAWINGS

FIG. 1 is a perspective view of the manner in which the disclosed system and method can be used with a data processing system having a data processing pipeline.

FIG. 2 is an example of an interim processing system of FIG. 1 that can have a data processing pipeline wherein latency is being measured.

FIG. 3 illustrates examples of tracer data injected into various data packets or carrier payloads

FIG. 3A illustrates additional examples of tracer data injected into various data packets or carrier payloads.

FIG. 4 is an illustration of a dashboard displaying latency time for a variety of data analysis systems that have data processing pipelines

FIG. 5A is an illustration of a dashboard displaying latency time for a variety of source platforms, that have data processing pipelines, as represented in FIG. 1.

FIG. 5B is an illustration of a dashboard displaying latency time for a variety of consuming product systems, as represented in FIG. 1

A component or a feature that is common to more than one drawing is indicated with the same reference number in each of the drawings.

### DESCRIPTION OF THE EMBODIMENT

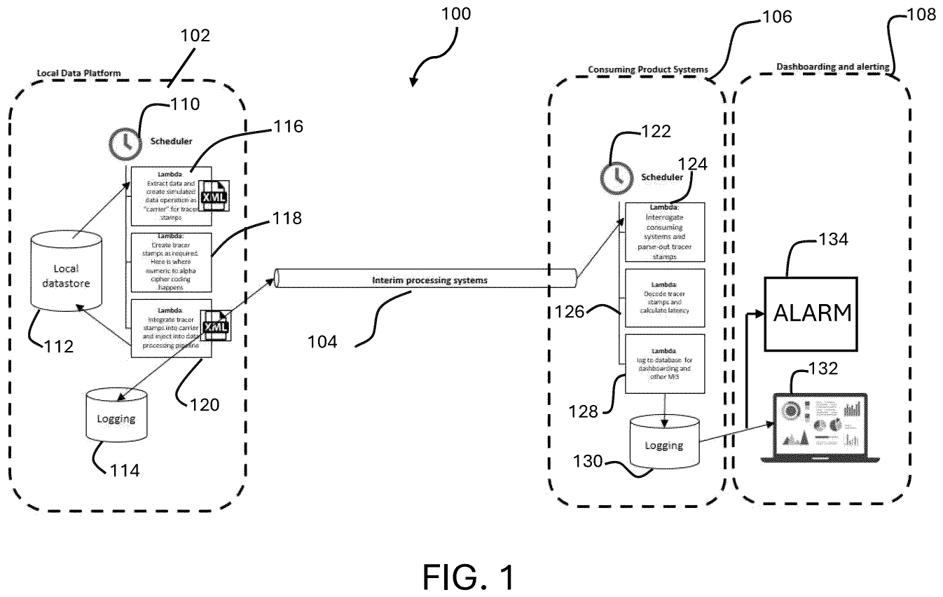

In FIG. 1 a data processing system 100 includes a local data platform 102, an interim processing system 104 (which can be any one of a large number of interim processing systems), having a data processing pipeline, a consuming product system 106 and a dashboard and alerting component 108. System 100 is configured, as described below, so that latency times can be measured.

Local data platform 102 includes a scheduler 110, a local data datastore and a logging function 114. Scheduler 110 is a task scheduler which regularly triggers a process illustrated as 116, for extracting data from local datastore 112 and creating a simulated data operation as a carrier for tracer time stamps, which may be in XML or other format (depending on the requirements of the data processing pipeline).

At 118 Lambda functions, or other techniques, can be used to create tracer stamps as required. As required, numeric to alpha cipher coding can be used. At 120, a Lambda function, or other suitable technique, integrates the tracer stamps into a carrier and injects them, possibly in XML or JSON (or any format as per the specific requirements of the data processing pipeline) into the interim processing system/s 104. Formats for the data elements are specifically designed to pass validation rules imposed by data ingestion and downstream processing. For example, formats for the data elements that can be supported include the following:

Datetime fields: No transformation/coding required—a full datetime value is provided.

Numeric fields: Tracer datetime is converted to a numeric string comprising year, month, day, hour and minute in a format of numeric fields: Tracer datetime can be represented as YYYYMMDDHHMM

Alpha fields: Tracer datetime is converted to alpha via cypher code with letters representing numbers, for example “caaeabbhhgcd”

Special fields—domain name: Tracer datetime is converted to alpha via cypher code with letters representing numbers then inserted to standard URL format, for example: www.caaeabbhhgcd.com”

Special fields—email address: Tracer datetime is converted to alpha via cypher code with letters representing numbers then inserted into standard email format; for example: caaeabbhhgcd@test.com.

Other formats can easily be created using the same principles. Regex can be used to validate the fields that were created.

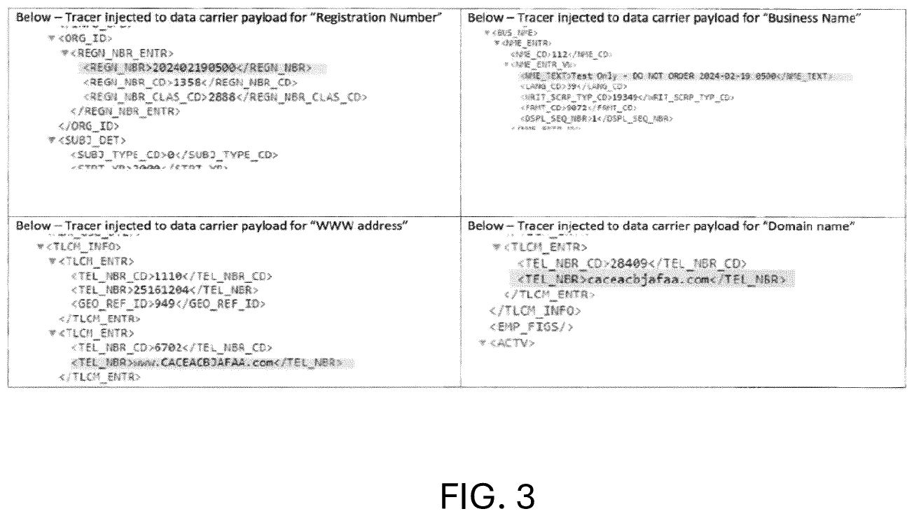

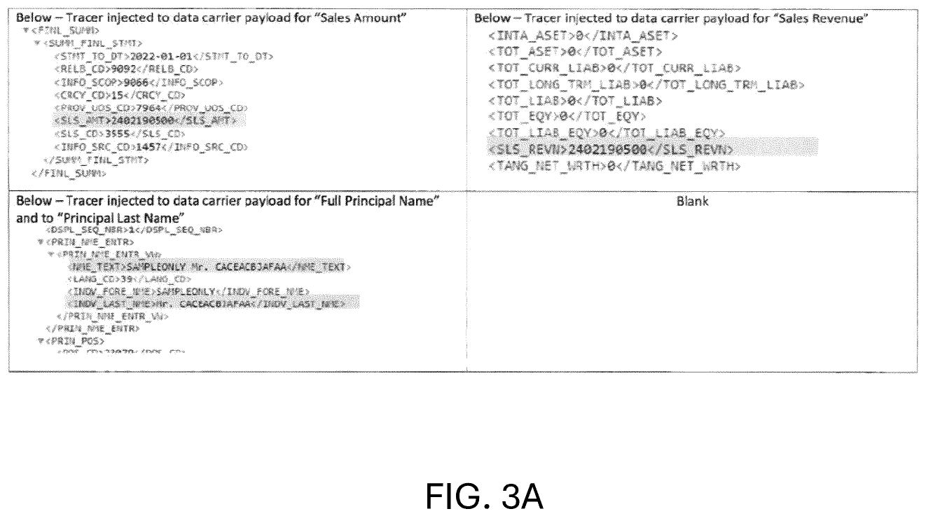

An associated process integrates the simulated data ingestion operation with the tracer stamps to appropriate fields in the data payload, as more fully described in the discussion of FIG. 3 and FIG. 3A, below.

A final process commits the payload of the data ingestion operation along with the tracing stamps and delivers to the data processing pipeline along with the tracing stamps for processing by downstream systems.

The data ingestion steps discussed above can be repeated periodically, for example, every hour.

The time of injection for each data stamp is logged by logging function 114.

Consuming product system 106 includes a scheduler 122 that uses a series of Lambda functions, or other functions techniques, as discussed above with respect to scheduler 110 of FIG. 1. At 124, the consuming product system 106 is interrogated and tracer stamps are parsed out. At 126, tracer stamps are decoded and latency for each stamp is calculated as the difference between the time and date stamp data and the current time and date. At 128, the time and date stamp data and the latency are logged to a logging function 130. This data from logging function 130 is made available for use by a visual display 132 or another alerting device or alarm 134 associated with dashboard and alerting component 108. For example, if latency is too large, which can in some circumstances be an indication that data is being delayed and is thus not current, an alarm can be triggered to indicate that conclusions reached by processing through the pipeline cannot be relied upon to be based on the most current data. Other conditions that can cause alerting due to large latency may include system capacity issues and early warnings of emerging system issues.

Thus, in accordance with this disclosure, a scheduled process regularly simulates system behavior and interrogates a product system. Tracer timestamps are extracted from the system being simulated as they arrive. Different data elements in a carrier package can be processed in different ways (for example, a company name data element may be processed differently than a URL data element). Depending on the nature of the data processing pipeline and the application in which it functions, this time can be varied between, for example, every minute to one per day. Generally, it is preferred to interrogate consuming customer systems at the same cadence with which the tracer stamps are injected into the data processing pipeline, that is on an hourly basis. However, ranges that provide operable results can include interrogating consuming customer systems every minute to once per day would provide operable results. For data processing pipelines that operate more rapidly, it may be advisable to interrogate consuming customer systems every few seconds. For slower processing pipelines a daily interrogation of consuming customer systems may be sufficient.

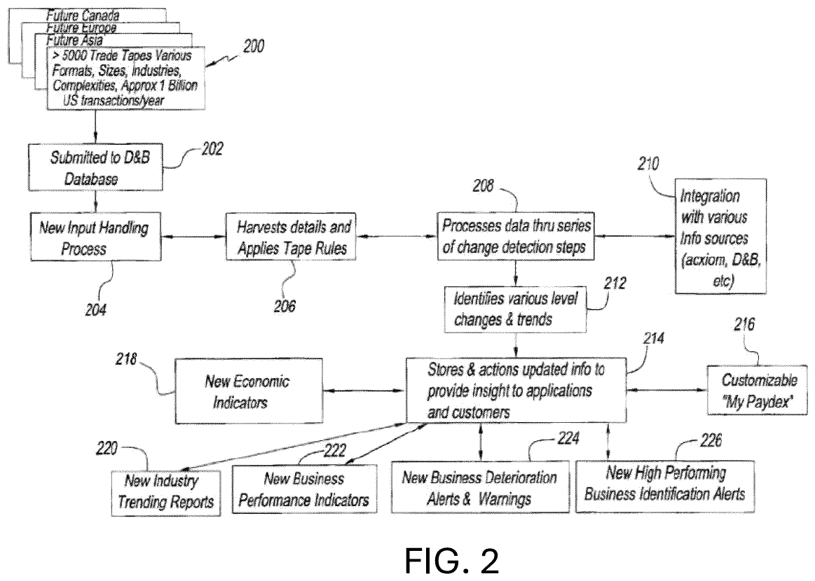

FIG. 2 (which is also FIG. 2 of U.S. Pat. No. 8,285,616) is a flowchart of a typical method embodying a data processing pipeline wherein latency can be measured and is merely one possible example of an interim processing system 104 of FIG. 1. It will be understood that FIG. 2 is described herein only by way of illustration, and not by way of limitation. In other words, the embodiment of the disclosure described herein may be utilized to determine latency in many other, different systems.

The data processing pipeline between data ingestion and product systems can be complex and consists of multiple steps and processes. However, it is not necessary to know or to understand the inner workings of the interim processing system when using the system and method disclosed herein. However, what is required is that the formatting of the tracer timestamps, and the data packet carriers into which the timestamps are embedded, will ensure that the interim data processing system will not reject or otherwise suppress the tracer timestamps or their respective data packet carriers. In other words, the timestamps need to be accepted and processed by the interim processing system in the same manner as normal production data flowing through the pipeline of the interim processing system. Thus, the timestamps and their carriers must be configured or transformed to be processed without being rejected by the data processing pipeline.

FIG. 2 illustrates processing of data to produce a credit report, wherein detail trade tapes 200 of various formats, sizes, and industries complexities are downloaded into a database 202. Thereafter, the detail trade information is processed through data handler 204 and then details are harvested therefrom and tape rules are applied 206. Once the tape rules are applied, the detail data is processed through a series of change detection steps 208, which is integrated with various information sources 210, e.g., Acxiom, Dun &Bradstreet, etc.). Thereafter, the system of FIG. 2 identifies various level changes and trends in the retrieved detail trade data 212 and then stores and actions updated information to provide insight to applications and customers 214. The stored detail trade data from step 214, then can be used to customize, for example, a Dun and Bradstreet@Paydex® report 216, or produce new economic indicators 218, new industry trending reports 220, new business performance indicators 222, new business deterioration alerts and warnings, 224, and new high performing business identification alerts 226.

FIG. 3 illustrates four examples of tracer or timestamp data inserted into a data packet or carrier in a manner so that interim processing systems in the data processing pipeline will not reject the tracer data as an invalid data element, when the data is transformed, as discussed above. The tracer data will be accepted and processed through to consuming product systems where the data can be extracted and analyzed.

In a first example, tracer data is injected into the data carrier for a field defined for the transport and processing of “Registration Number” data. The tracer data is converted to a numeric string which has the corresponding characteristics of a valid Registration Number,

In a second example, tracer data is injected into the data carrier for a field defined for the transport and processing of “Business Name” data. The tracer data is converted to a character string which has the corresponding characteristics of a valid Business Name.

In a third example, tracer data is injected into the data carrier for a field defined for the transport and processing of “WWW address” data. The tracer data is converted to a character string which has the corresponding characteristics of a valid WWW address.

In a fourth example, tracer data is injected into the data carrier for a field defined for the transport and processing of “Domain name” data. The tracer data is converted to a character string which has the corresponding characteristics of a valid domain name.

FIG. 3A illustrates three additional examples of tracer or timestamp data inserted into a data packet or carrier.

In another example, tracer data is injected into the data carrier for a field defined for the transport and processing of “Sales Amount” data. The tracer data is converted to a string of numbers which has the corresponding characteristics of the dollar amount of sales.

In an additional example, tracer data is injected into the data carrier for a field defined for the transport and processing of “Sales Revenue” data. The tracer data is converted to a string of numbers which has the corresponding characteristics of the dollar amount of net sales.

In yet another example, tracer data is injected into the data carrier for a field defined for the transport and processing of “Full Principal Name or “Principal Last Name” data. The tracer data is converted to a string of characters which corresponds to the name of the principal

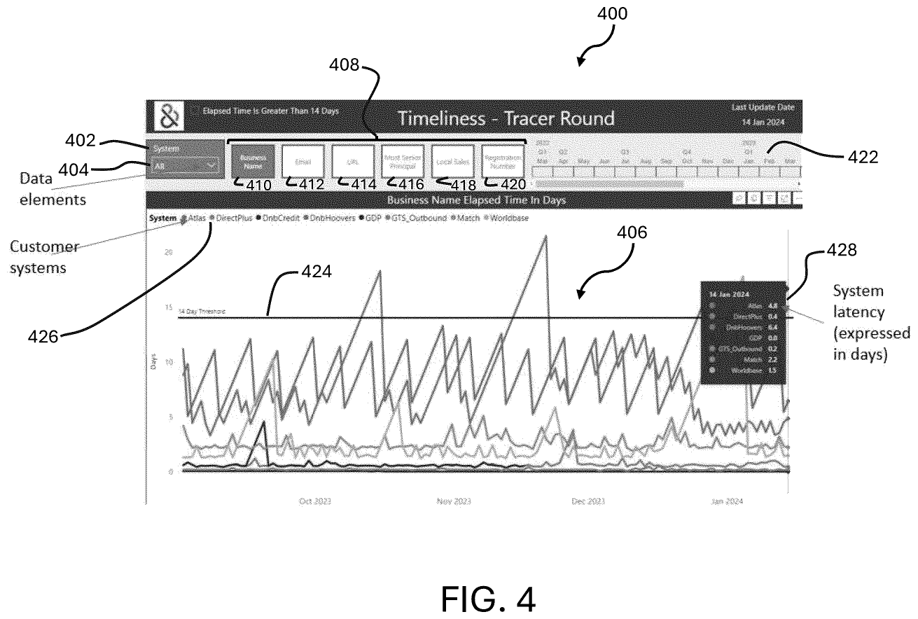

FIG. 4 illustrates a possible form of a dashboard 400 displaying latency time for a variety of data analysis systems that have data processing pipelines, The various displayed elements are discussed below.

A selector 402, uses a drop menu accessed at 404 to choose the display or suppression of the display of data latency graphs or charts 406 in various consuming product systems 106, of the kind described in FIG. 1.

A selector, shown generally as 408 is used to choose the display or suppression of display of data latency charts for specific data elements. These elements can include, for example, business name 410, email address 412, URL 414, most senior principal 416, local sales 418 and registration number 420.

A calendar control 422 is used to select the date range of the data latency charts, which dates can be displayed below the latency charts 406.

A user defined threshold that will trigger alerts if latency exceeds such threshold is illustrated as a horizontal line 424 on the latency charts 406. On the charts, the X axis represents the date, while the Y axis represents latency in number of days for that date.

Each line on the chart represents the latency (in days) for a specific data element (in FIG. this is for “Business Name” which has been selected at 410) for various selected consuming product systems (106 in FIG. 1). For ease of interpretation, the color for each of the plotted latency charts 406 can be identified at a color legend 426.

At 428 a hover-over summary allows users to see detailed latency statistics at any point in time as displayed on the charts 406. For example, system latency can be expressed in days for various systems.

It is noted that there are two main reasons that there is latency in data processing. One is that data is physically transferred from one system to another as batch feeds. Batch feeds run at various frequencies and at various capacities. Generally, the older the system the slower/less capacity it has to transfer data. This can result in multi-day delays in moving data. Another is that some systems use a “pod swap” approach to refreshing datastores, e.g.: serve customers production data from a “pod A” while data is flowing into and refreshing a “pod B”. At predetermined intervals, pod A and pod B are swapped, so that now pod B serves customers production data while pod A is being refreshed. This pod swap behavior can be observed as sawtooth latency graphs in, for example, FIG. 4, where latency progressively rises until the pod swap occurs, at which time the latency goes down again.

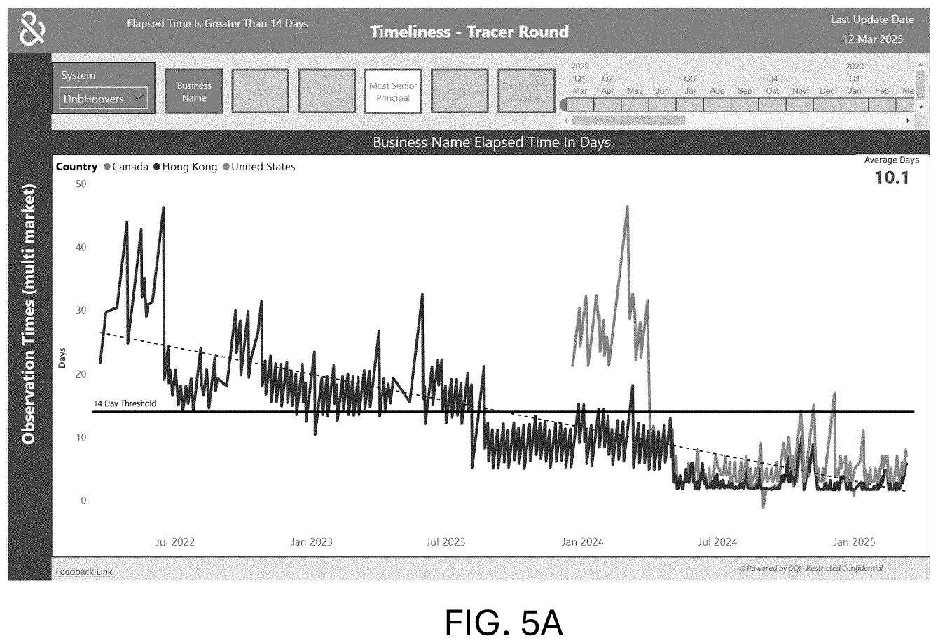

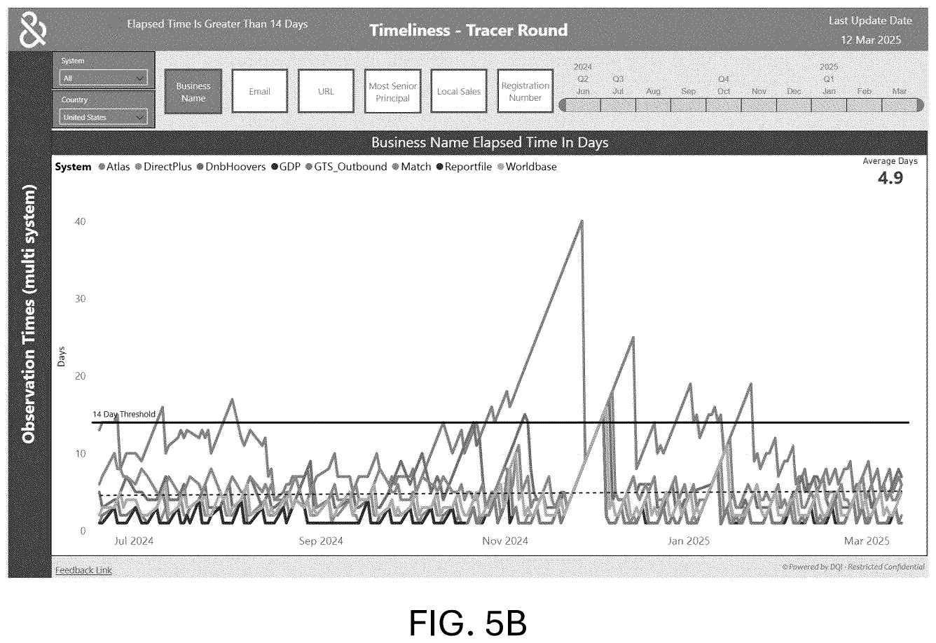

FIGS. 5A and 5B are display alternatives to the display of FIG. 4. In FIG. 5A, each “market” or country (for example, Canada, Hong Kong or the United States are shown) represents a source platform (FIG. 1, reference numeral 102). The latency, in days, is displayed as a function of time for these markets. The general trend shown in FIG. 5A is a decrease in latency as a function of time.

FIG. 5B, is similar to FIG. 4. Each “system” in 5B represents a consuming product system (FIG. 1, reference numeral 106).

Data that is injected into a data processing pipeline may be obtained from any number of systems and primary sources. For example, business data sources that typically can be utilize include batch and transactional data obtained from external providers such as business registries, court lists, financial data feeds, external API's, human data entry, etc. Normally, such data is first processed by a local data platform where the data is pre-validated, standardized, aggregated then delivered as a data payload to a data processing pipeline for transport and consumption by downstream product systems.

The methods and systems disclosed herein provide, in essence, instrumentation for measuring data flow latency in an end-to-end data processing pipeline. They can be used to sound an alarm if latency times become excessive or to gain insights as to where or what in the pipeline is causing delays if changes in the processing in the pipeline occurs or are deliberately made. This valuable information, possibly useful for improving the data pipeline can be generated using the methods and system disclosed herein.

The techniques described herein are exemplary and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

What is claimed is:

1. A method for measuring data flow latency in an end-to-end data processing pipeline comprising the steps of:
periodically injecting a plurality of numerical date-time stamped data packets into the data processing pipeline, the data packets being configured so that they are not rejected by the pipeline as in an unacceptable format, and not processed by the pipeline as valid data, and
determining when each of the plurality of data packets has been processed out of the pipeline to derive measures of the latency time between when each of the plurality of data packets was injected into the pipeline and when the respective data packet was processed out of the pipeline.

2. The method of claim 1, further comprising converting the numerical date-time stamps into alpha cipher code compliant with processing in the pipeline.

3. The method of claim 2, further comprising aggregating the measures of latency time.

4. The method of claim 2, further comprising aggregating the measures of latency time to produce a graph of the manner in which latency time varies as a function of time.

5. The method of claim 4, further comprising displaying the graph on a user dashboard.

6. The method of claim 4, wherein the graph comprises a first display of latency of markets as a function of time, and a second display of latency of user systems as a function of time.

7. The method of claim 1, wherein the latency time is determined in part by how often data, including the date-time stamped data packets, are uploaded to the pipeline.

8. The method of claim 1, wherein the data packets act as carriers for date and time data in addition to other data processed by the data processing pipeline.

9. The method of claim 1, further comprising sounding an alarm when the measures of the latency time indicate an abnormal condition in the data processing pipeline.

10. The method of claim 9, wherein the abnormal condition is at least one of insufficient system capacity and undue processing delays.

11. A system for measuring data flow latency in an end-to-end data processing pipeline operating in accordance with the steps of claim 1.

12. A system for measuring latency of data processing in a data processing pipeline, comprising:
a first digital processor which periodically injects a plurality of numerical date-time stamped data packets into the data processing pipeline, the packets being configured so that they are not rejected by the pipeline as in an unacceptable format, and not processed by the pipeline as valid data, and
a second digital processor which determines when each of the plurality of data packets has been processed out of the pipeline to derive measures of the latency time between when each of the plurality of data packets was injected into the pipeline and when the respective data packet was processed out of the pipeline.

13. The system of claim 12, further comprising an additional digital processor for converting the numerical date-time stamps into alpha cipher code compliant with processing in the pipeline.

14. The system of claim 13, further comprising an additional digital processor for aggregating the measures of latency time.

15. The system of claim 13, wherein the additional digital processor further aggregates the measures of latency time to produce a graph of the manner in which latency time varies as a function of time.

16. The system of claim 15, further comprising a display for displaying the graph on a user dashboard.

17. The system of claim 15, further comprising a first display of latency of markets as a function of time, and a second display of latency of user systems as a function of time.

18. The system of claim 12, wherein the latency time is determined in part by how often data, including the date-time stamped data packets, are uploaded to the pipeline.

19. The system of claim 12, wherein the data packets act as carriers for date and time data in addition to other data processed by the data processing pipeline.

20. The system of claim 12, further comprising an alarm that is sounded when the measures of the latency time indicate an abnormal condition in the data processing pipeline.

21. The system of claim 20, wherein the abnormal condition is at least one of insufficient system capacity and undue processing delays.
